(19) United States
(12) Patent Application Publication
(10) Pub. No.: US 2007/0205665 A1
(43) Pub. Date: Sep. 6, 2007

(54) Power Tool with Power Supply Circuit Supplying Different Level DC Voltages to Different Auxiliary Devices

(76) Inventors: Yoshikazu Kawano, Hitachinaka-shi (JP); Nobuhiro Takano, Hitachinaka-shi (JP); Shigeharu Ushiwata, Hitachinaka-shi (JP); Kenichi Matsunaga, Hitachinaka-shi (JP); Hirohisa Tomita, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/680,707

(22) Filed: Mar. 1, 2007

(30) Foreign Application Priority Data
Mar. 2, 2006 (JP) P2006-057032

(51) Int. Cl. H02J 3/14

(52) U.S. Cl. 307/31

(57) ABSTRACT

An electrically-driven power tool includes a power supply circuit capable of outputting a plurality of DC voltages different in level through conversion of a commercial AC voltage. A lamp and its associated switch are provided. When the switch is turned ON to light the lamp, the DC voltage is applied to the lamp so that voltage gradually increases up to a predetermined level during a predetermined period of time. By doing so, a voltage being applied, for example, to a microcomputer from the power supply circuit is prevented from momentarily lowering at the time when the switch is turned ON.

### BACKGROUND OF THE INVENTION

1. Field of the Invention

The present invention relates generally to electrically-driven power tools, such as a miter saw, and more particularly, to an electrically-driven power tool provided with a power supply circuit capable of supplying different level DC voltages each to different auxiliary devices, such as lighting device and display device.

2. Description of the Related Art

Japanese Patent Application Publication No. 2005-111855 discloses a miter saw capable of cutting a workpiece to have a desired angled cut facet. To aid the cutting operation, the miter saw is generally provided with some auxiliary devices, such as a lighting device for enabling the cutting operation to be performed in a dark environment, a laser beam output device for irradiating a laser beam onto the workpiece to indicate the cutting line of the workpiece, and a computer-controlled display device for displaying information about an angle of a plane along which the workpiece is cut.

Generally, the auxiliary devices are not operated with the same DC voltage but operated with different level DC voltages. Using a plurality of power supply circuits suitable for the respective auxiliary devices is disadvantageous in terms of cost. Using a single power supply circuit capable of separately outputting a plurality of DC voltages different in level is also disadvantageous in that the DC voltage being supplied to one auxiliary device is momentarily lowered when supplying a different level DC voltage to another auxiliary device.

### SUMMARY OF THE INVENTION

Accordingly, an object of the invention is to provide an inexpensive power supply circuit for use in an electrically-driven power tool.

Another object of the invention is to provide an electrically-driven power tool having a plurality of auxiliary devices, wherein a single power supply circuit is configured to stably output a plurality of different level DC voltages to be applied to the auxiliary devices.

To achieve the above and other objects, there is provided a power tool that includes a power supply circuit configured to output a plurality of DC voltages different in level including a first DC voltage and a second DC voltage; a first auxiliary unit supplied with the first DC voltage from the power supply circuit; a second auxiliary unit having a switch and being supplied with a voltage changing up to the second DC voltage during a predetermined period of time, and supplied with the second DC voltage after expiration of the predetermined period of time up to a time when the switch is turned OFF.

The power supply circuit can be configured at low cost, yet preserving reliable operation.

The invention is particularly useful in the case when the second DC voltage is greater than the first DC voltage.

The first auxiliary unit may, for example, be a microcomputer. The microcomputer includes a memory and executes a process based on data stored in the memory while updating the data in the memory.

A time constant circuit may preferably be connected to the switch wherein the time constant circuit gradually increases the voltage applied to the second auxiliary unit up to the second DC voltage during the period of time determined by a time constant of the time constant circuit.

The power tool may further includes a movable part, and a detection section that detects a position of the movable part and outputs the data indicative of the position of the movable part.

According to another aspect of the invention, there is provided a miter saw that includes a base on which a workpiece is placed; a turntable rotatable relative to the base; a motor; a cutting portion including a cutting blade driven by the motor; a coupling member that couples the cutting portion to the turntable so that the cutting portion is rotatable together with the turntable, pivotally movable toward and away from the base, and tiltable relative to the base, the workpiece being cut when the cutting portion is moved toward the base; a first detector that detects a position of the turntable relative to the base and outputs a first detection signal indicative of the position of the turntable; a second detector that detects a degree of tilt of the cutting portion relative to the base and outputs a second detection signal indicative of the degree of tilt of the cutting portion; a control section that receives the first and second detection signals and produces display data based on the first and second detection signals; a display device that receives the display data from the control section and displays information about a cutting position and a cutting plane of the workpiece; a power supply circuit configured to output a plurality of DC voltages different in level including a first DC voltage and a second DC voltage, the control unit being supplied with the first DC voltage and an auxiliary unit having a switch and being supplied with a voltage changing up to the second DC voltage during a predetermined period of time, and supplied with the second DC voltage after expiration of the predetermined period of time up to a time when the switch is turned OFF.

The invention as defined above is particularly advantageous in the case when the second DC voltage is greater than the first DC voltage. In this case, the first and second detectors are supplied with the first DC voltage.

The control unit includes a memory and executes a process based on data stored in the memory while updating the data in the memory to produce the display data.

The power tool may further includes a time constant circuit connected to the switch wherein the time constant circuit gradually increases the voltage applied to the auxiliary unit up to the second DC voltage during the period of time determined by a time constant of the time constant circuit.

### BRIEF DESCRIPTION OF THE DRAWINGS

The particular features and advantages of the invention as well as other objects will become apparent from the following description taken in connection with the accompanying drawings, in which:

FIG. 1 is a perspective view showing a miter saw according to one embodiment of the invention;

FIG. 2 is a circuit diagram showing a power supply circuit incorporated in the miter saw shown in FIG. 1;

FIG. 3 is a block diagram of a display control circuit for controlling a display device mounted on the miter saw shown in FIG. 1;

FIG. 4 is a graphical representation showing output current/voltages from a conventional power supply circuit when a lamp is turned on; and

FIG. 5 is a graphical representation showing output current/voltages from the power supply circuit according to the embodiment of the invention.

### DETAILED DESCRIPTION OF THE PREFERRED EMBODIMENTS

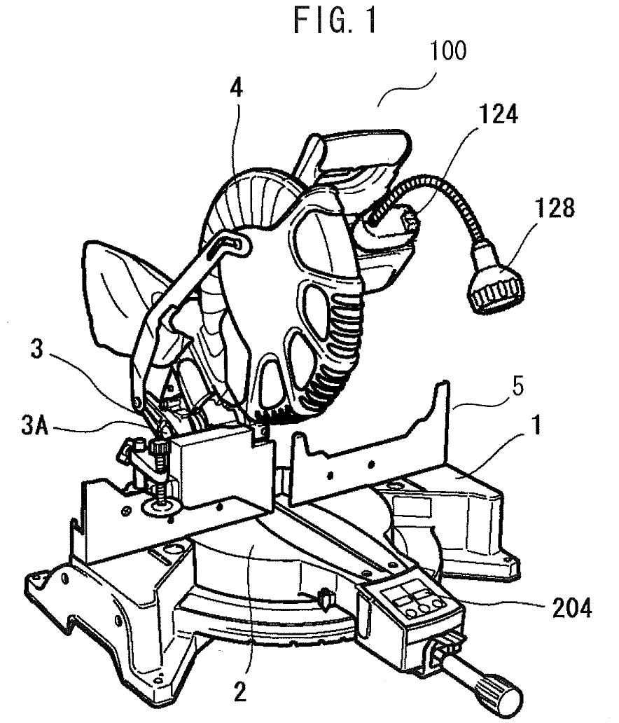

An embodiment of the invention will be described while referring to the accompanying drawings. In the following description, a miter saw 100 will be described as one of the examples of electrically-driven power tools. FIG. 1 is a perspective view showing the miter saw 100. The terms “upward”, “downward”, “upper”, “lower”, “above”, “below”, “beneath” and the like will be used throughout the description assuming that the miter saw 100 is disposed in an orientation in which it is intended to be used.

As shown in FIG. 1, the miter saw 100 basically includes a base 1, a turntable 2, a holder 3, and a cutting portion 4. Although not shown in FIG. 1, the miter saw 100 further includes a motor, and a cutting blade driven by the motor. The turntable 2 has a top surface substantially in flush with the top surface of the base 1 and is rotatable relative to the base 1 held stationary. A workpiece (not shown) is held on the base 1 to be in abutment with an upstanding positioning wall 5 on the base 1.

The holder 3 is coupled to the turntable 2 with a tilt shaft (not shown) held at substantially the same height as the top surface of the turntable 2. The holder 3 is also coupled to the cutting portion 4 with a pivot shaft 3A positioned above the tilt shaft. The cutting portion 4 supported by the holder 3 is thus pivotally vertically movable about the pivot shaft 3. Downward movement of the cutting portion 4 cuts the workpiece placed on the base 1. Also, the cutting portion 4 is tiltable about the tilt shaft to be out of an orthogonal relation with the base 1. Thus, the cutting portion 4 is pivotally vertically movable while maintaining the tilted state, so that the workpiece is cut to have a slanted or angled cut facet. Further, by rotating the turntable 2, the line across which the workpiece is to be cut can be arbitrarily selected.

In accordance with this embodiment, the miter saw 100 has two auxiliary devices, i.e., a display device 204 and a lighting device or a lamp 128. In this embodiment, the display device 204 uses a liquid crystal display (LCD). As will be described in detail hereinafter, the display device 204 is used to display information about an angle of a plane along which the workpiece is cut. More specifically, the display device 204 digitally displays tilt angle of the cutting portion 4 and also a rotating angle of the turntable 2. The lamp 128 irradiates light onto the working area and enables the cutting operation to be performed even in a dark environment. A switch 124 is provided for turning ON and OFF the lamp 124.

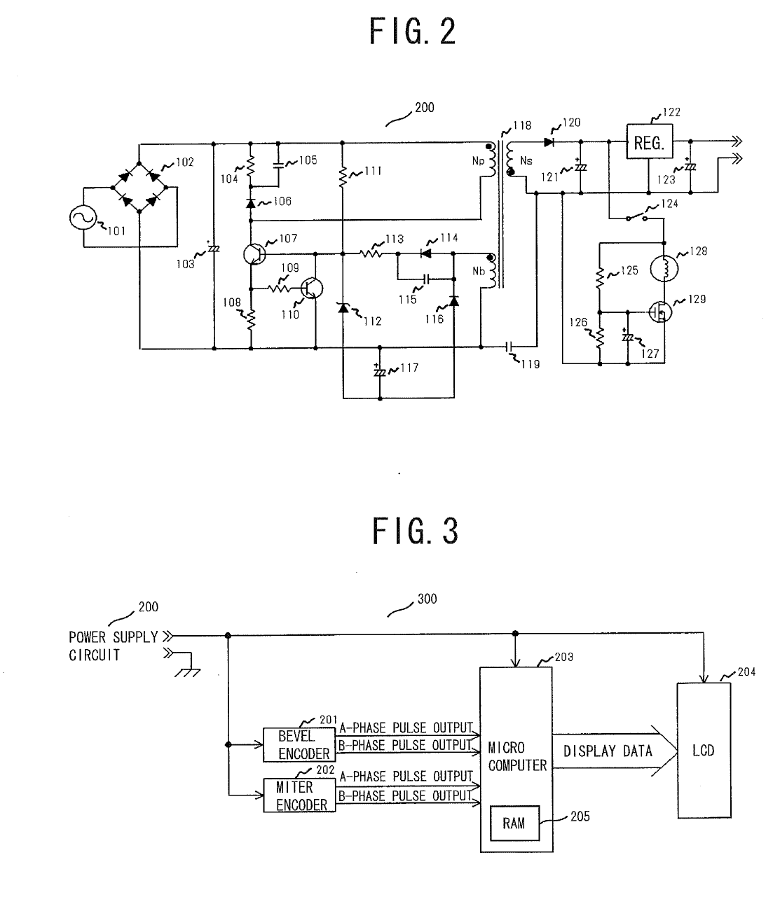

As shown in FIGS. 2 and 3, the miter saw 100 further includes a power supply circuit 200, and a display control circuit 300. As will be described later in far more detail, the power supply circuit 200 in this embodiment is capable of supplying two DC voltages different in level, one being the voltage developed across an electrolytic capacitor 123 connected at the output side of a three-terminal regulator 122 and the other being the voltage developed across a electrolytic capacitor 121. The former and latter voltages will hereinafter referred to as “first DC voltage” and “second DC voltage”, respectively.

The display control circuit 300 includes a bevel encoder 201, a miter encoder 202, and a microcomputer 203, all of which are supplied with the first DC voltage from the power supply circuit 200. The bevel encoder 201 detects a tilt angle of the cutting portion 4 and outputs a tilt angle detection signal. It should be noted that the posture of the holder 3 is changed as the cutting portion 4 is tilted. Accordingly, the tilt angle is given by detecting the positional change of the holder 3. The tilt angle detection signal is composed of A-phase pulses and B-phase pulses for indicating how much degree the cutting portion 4 is tilted from a reference position and also the direction in which the cutting portion 4 is tilted. The A-phase and B-phase pulses are generated at every predetermined angle the cutting portion 4 is tilted. The miter encoder 202 detects a rotation angle of the turntable 2 relative to the base 1 and outputs a rotational angle detection signal. The rotational angle detection signal is also composed of A-phase pulses and B-phase pulses for indicating how much degree the turntable 2 is rotated from a reference position and the direction in which the turntable 2 is rotated. The A-phase and B-phase pulses of the rotational angle detection signal are generated at every predetermined angle the turntable 2 is rotated.

As shown in FIG. 3, the microcomputer 203 is connected to the outputs of the bevel encoder 201 and the miter encoder 202 and counts the number of pulses produced from each encoder. The microcomputer 203 includes a random access memory (RAM) 205 in which the count numbers of the pulses are temporarily stored. Based on the data stored in the memory 205, the microcomputer 203 executes an angle calculating process for calculating the tilt angle of the holder 3 and the rotational angle of the turntable 2. The resultant angle data are sent to the LCD 204 for digitally indicating the calculated angles. At every predetermined interval, the microcomputer 203 recalculates the angles based on the updated data fed from the bevel encoder 291 and the miter encoder 202 and the LCD 204 displays updated information. As such, the operator can recognize an angle of a plane along which the workpiece is cut from the information currently displayed on the LCD 204.

An arrangement of the power supply circuit 200 shown in FIG. 2 will be described. It should be noted that the circuit diagram shown in FIG. 2 includes not only the power supply circuit 200 but also a lamp 128 and its control circuit configured from resistors 125 and 126, an electrolytic capacitor 127 and a field effect transistor (FET) 129 connected to the lamp 128. The resistor 126 and the capacitor 127 form a time constant circuit which is connected to the gate of the FET 129.

The power supply circuit 200 includes a rectifying/smoothing circuit configured from a diode bride 102 and a smoothing capacitor 103. In use, the diode bridge 102 is connected to a commercial AC power supply 101. The circuit 200 further includes a switching transistor 107 having a collector connected to a clamp-snubber circuit configured from a resistor 104, a capacitor 105 and a diode 106. To the emitter of the transistor 107, an overcurrent prevention circuit is connected, which is configured from resistors 108 and 109, and a transistor 110. First and second transistor control circuits are connected to the base of the transistor 107 to control ON/OFF of the transistor 107. The first transistor control circuit is configured from a resistor 111, a Zenor diode 112, and an electrolytic capacitor 117. The second transistor control circuit is configured from a resistor 113, diodes 114 and 116, a capacitor 115 connected in parallel with the diode 114, and a tertiary winding Nb of a transformer 118.

Other than the tertiary winding Nb, the transformer 118 includes a primary winding Np and a secondary winding Ns. A rectifying diode 120, the electrolytic capacitor 121, the three-terminal regulator 122, and the electrolytic capacitor 123 are connected to the secondary winding Ns. A noise-suppressing capacitor 119 is connected between the secondary winding Ns and the tertiary winding Nb.

In operation, when the power supply circuit 200 is connected to the commercial AC power supply 101, the AC voltage supplied from the commercial AC power supply 101 is rectified by the diode bridge 102 and smoothed by the electrolytic capacitor 103, thereby producing a DC voltage across the capacitor 103. Then, the first transistor control circuit including the resistor 111 is rendered active so that the transistor 107 is turned ON. As the primary winding Np of the transformer 116 is applied with a voltage when the transistor 107 is turned ON, a voltage is developed across the tertiary winding Nb of the transformer 118. The voltage developed across the tertiary winding Nb of the transformer 118 is applied to the base of the transistor 107 via the diode 114 and the resistor 113 of the second transistor control circuit so that the transistor 107 maintains the ON state. When the collector current of the transistor 107 (or the current flowing in the primary winding Np) is increased to meet the current-amplification factor h_{FE} of the transistor 107, the transistor 107 is turned OFF.

When the current flowing in the primary winding Np is interrupted, the secondary winding Ns generates a counter-electromotive force, allowing a current to flow in the electrolytic capacitor 121 via the diode 120. The electrolytic capacitor 121 is thus charged.

When energy accumulated in the transformer 118 is released, a small amount of energy remaining in the secondary winding Ns generates a voltage across the tertiary winding Nb, causing the transistor 107 to turn ON again. Such switching actions repeatedly performed by the transistor 107 converts the input AC voltage to a DC voltage. At this time, the voltage across the electrolytic capacitor 117 changes in proportion to the voltage developed across the electrolytic capacitor 121. Accordingly, when the voltage of the Zenor diode 112 exceeds a sum of the voltage across the electrolytic capacitor 117 and the base-to-emitter voltage of the transistor 107, the base current for turning ON the transistor 107 flows in the Zenor diode 112, so that the transistor 107 is turned OFF. In this manner, the electrolytic capacitor 121 is charged to output a constant voltage.

The resistor 108 is used to detect the current flowing in the transistor 107 and applies a voltage determined depending upon the detected current to the base of the transistor 110 via the resistor 109. When the voltage across the resistor 108 or the emitter current of the transistor 107 exceeds a predetermined value, the transistor 110 is turned ON, causing the base current of the transistor 107 to interrupt. More specifically, the resistors 108 and 109 and the transistor 110 function as the overcurrent prevention circuit for preventing an overcurrent from flowing in the transistor 107 or the primary winding Np. The resistor 104, capacitor 105, and the diode 106 forms the clamp-snubber circuit for protecting the transistor 107 from the counter-electromotive force generated in the primary winding Np when the transistor 107 is turned OFF. The capacitor 119 is provided for suppressing noises.

The voltage developed across the electrolytic capacitor 121 is derived as the second DC voltage and applied to the lamp control circuit via the switch 124 and also applied to the three-terminal regulator 122. The regulator 122 converts the input voltage or the second DC voltage from the electrolytic capacitor 121 to the first DC voltage. The first DC voltage is applied to the display control circuit 300 shown in FIG. 3. In accordance with this embodiment, the second DC voltage applied to the lamp control circuit is 12 volts, and the first DC voltage applied to the display control circuit 300 is 5 volts. It should be noted that the voltage applied to the lamp control circuit is greater than the voltage applied to the display control circuit 300 including the microcomputer 203.

When the switch 124 of the lamp 128 is turned ON, current flows via the resistor 125 into the electrolytic capacitor 127 to charge the same. The voltage across the electrolytic capacitor 127 gradually increases in accordance with a time constant determined by the resistance of the resistor 125 and the capacitance of the electrolytic capacitor 127. The voltage across the electrolytic capacitor 127 is applied to the gate of the FET 129. The current flowing in the FET 129 is in proportion to the voltage applied to the gate of the FET 129. Accordingly, the current flowing in the lamp 128 gradually increases as the time passes during a predetermined period of time.

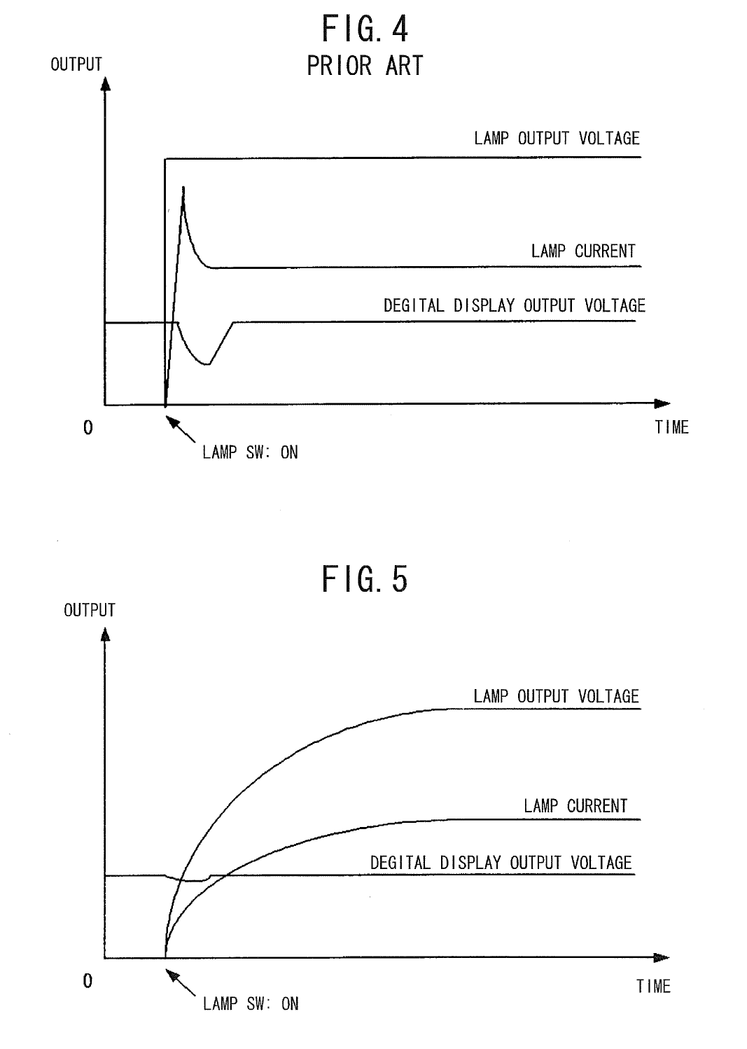

In a conventional miter saw, an extremely large rush current flows in the filament of the lamp when the lamp is turned ON. This is because the electrical resistance of the lamp is small due to low internal temperature at the time when the lamp is turned ON. As shown in FIG. 4, the voltage applied to the microcomputer 203 may fall below the operating voltage of the microcomputer 203. In accordance with the embodiment of the invention, the load imposed upon the power supply circuit 200 does not abruptly change as shown in FIG. 5, so that the voltage applied to the lamp control circuit does not abruptly change. Further, the rush current which may flow in the lamp 128 can also be prevented. Therefore, the service life of the lamp 128 can be prolonged.

As described above, a predetermined period of time is reserved just after the switch 124 of the lamp 128 is turned ON, during which time the voltage applied to the lamp 128 is gradually increased up to the second DC voltage. As a result of the gradual increase of the voltage applied to the lamp 128, the microcomputer 203 does not suffer from substantial voltage variation of the first DC voltage applied thereto. Therefore, the microcomputer 203 operates stably even when the lamp 128 is switched ON.

If the voltage applied to the microcomputer 203 is greatly lowered at the time when the switch 124 is turned ON, the microcomputer 203 is shut down and the data stored in the memory 205 is lost. Shut down of the microcomputer during the cutting operation with the cutting portion 4 of the miter saw 100 causes confusion or inconvenience to the operator. When the operator is adjusting the position of the turntable 2 while checking numerically indicated rotational angel of the turntable 2 indicated in the LCD 204, the indicated angle in the LCD 204 disappears when the lamp 128 is turned ON, and then the LCD 204 indicates an angle of zero because the microcomputer 203 is once shut down and then powered again.

In accordance with the embodiment of the invention, generation of misleading information which may mislead the operator when operating the miter saw 100 is prevented and a reliable miter saw 100 is provided in which the output voltage from the power supply circuit 200 is not lowered to a level causing the microcomputer 203 to shut down. To this end, the output voltage from the power supply circuit 200 for turning the lamp 128 ON is gradually increased. It is therefore not necessary to enhance the voltage output capability of the power supply circuit or to employ a feedback type power supply circuit with an excellent response characteristic.

In the foregoing description, the count numbers of the pulses of the pulse signals fed from the encoders 201 and 202 have been taken an example of the data stored in the memory of the microcomputer 203. However, other types of data may be detected and stored for indication in the LCD 204.

Although the invention has been described with respect to a specific embodiment, it will be appreciated by one skilled in the art that a variety of changes may be made without departing from the scope of the invention. For example, a laser irradiation device may be provided in place of the lamp 128.

Further, while the invention has been described with reference to the miter saw 100 having the display device 204, a laser irradiating device may be provided for instructing the cut line of the workpiece in place of the display device 204. Also, the invention can be applied not only to the miter saw but also other types of power tools, such as screw driver, circular saw, router, and hammer, which have a plurality of auxiliary devices. The invention is particularly useful to apply to power tools incorporating a microcomputer used for producing information to be given to the operator.

What is claimed is:

1. A power tool comprising:
a power supply circuit configured to output a plurality of DC voltages different in level including a first DC voltage and a second DC voltage;
a first auxiliary unit supplied with the first DC voltage from the power supply circuit;
a second auxiliary unit having a switch and being supplied with a voltage changing up to the second DC voltage during a predetermined period of time, and supplied with the second DC voltage after expiration of the predetermined period of time up to a time when the switch is turned OFF.

2. The power tool according to claim 1, wherein the second DC voltage is greater than the first DC voltage.

3. The power tool according to claim 1, wherein the first auxiliary unit comprises a microcomputer.

4. The power tool according to claim 3, wherein the microcomputer includes a memory and executes a process based on data stored in the memory while updating the data in the memory.

5. The power tool according to claim 1, further comprising a time constant circuit connected to the switch wherein the time constant circuit gradually increases the voltage applied to the second auxiliary unit up to the second DC voltage during the period of time determined by a time constant of the time constant circuit.

6. The power tool according to claim 4, further comprising a movable part, and a detection section that detects a position of the movable part and outputs the data indicative of the position of the movable part.

7. A miter saw comprising:
a base on which a workpiece is placed;
a turntable rotatable relative to the base;
a motor;
a cutting portion including a cutting blade driven by the motor;
a coupling member that couples the cutting portion to the turntable so that the cutting portion is rotatable together with the turntable, pivotally movable toward and away from the base, and tiltable relative to the base, the workpiece being cut when the cutting portion is moved toward the base;
a first detector that detects a position of the turntable relative to the base and outputs a first detection signal indicative of the position of the turntable;
a second detector that detects a degree of tilt of the cutting portion relative to the base and outputs a second detection signal indicative of the degree of tilt of the cutting portion;
a control section that receives the first and second detection signals and produces display data based on the first and second detection signals;
a display device that receives the display data from the control section and displays information about a cutting position and a cutting plane of the workpiece;
a power supply circuit configured to output a plurality of DC voltages different in level including a first DC voltage and a second DC voltage, the control unit being supplied with the first DC voltage and
an auxiliary unit having a switch and being supplied with a voltage changing up to the second DC voltage during a predetermined period of time, and supplied with the second DC voltage after expiration of the predetermined period of time up to a time when the switch is turned OFF.

8. The miter saw according to claim 7, wherein the second DC voltage is greater than the first DC voltage.

9. The mite saw according to claim 7, wherein the first and second detectors are supplied with the first DC voltage.

10. The miter saw according to claim 9, wherein the control unit includes a memory and executes a process based on data stored in the memory while updating the data in the memory to produce the display data.

11. The miter saw according to claim 7, further comprising a time constant circuit connected to the switch wherein the time constant circuit gradually increases the voltage applied to the auxiliary unit up to the second DC voltage during the period of time determined by a time constant of the time constant circuit.
